(19) United States
(12) Patent Application Publication
(10) Pub. No.: US 2021/0010455 A1
(43) Pub. Date: Jan. 14, 2021

(54) WIND FLOW OPERATED VENTILATION AND ENERGY HARNESSING DEVICE

(71) Applicant: Ahmad Muna Hussain, Bengaluru (IN)

(72) Inventor: Ahmad Muna Hussain, Bengaluru (IN)

(21) Appl. No.: 16/982,764

(22) PCT Filed: Jan. 14, 2019
(86) PCT No.: PCT/IN2019/050035

§ 371 Date: Sep. 21, 2020

(30) Foreign Application Priority Data
Jan. 23, 2018 (IN) 201831002689

(51) Int. Cl. F03D 1/04; F03D 80/70

(52) U.S. Cl. CPC F03D 1/04; F03D 80/70; F05B 2220/602; F05B 2250/71; F05B 2240/50; F05B 2240/57; F05B 2260/64

(57) ABSTRACT

Disclosed is wind flow operated ventilation and energy harnessing device, comprising an L-shaped flow pipe (101/201) with one arm sweeping horizontally while the other rotatable on a stationary vertical pipe (102/202) connected with the space being ventilated. The open end of the horizontal portion is flared into collar (106) or bell-shaped mouth (206) forming evacuating or pressurizing flow pipe respectively. The direction changers (108/208) are used to maintain the back of collar (107) of flared portion (106) or open end (207) of bell-shaped mouth (206) facing upstream wind. The wind on striking the back of collar (107) or the open end (207) of bell-shaped mouth (206) creates evacuation or pressurization effect respectively for ventilation. A wind turbine fitted inside stationary vertical pipe harnesses energy.

### TECHNICAL FIELD

In this invention there is a direct utilization of the energy of natural wind flow in creating ventilation effect without the involvement of any rotating machine or the consumption of energy from any external source.

### BACKGROUND ART

The devices used for ventilation, here-to-fore known, consume energy in rotating mechanical parts. These devices, besides extra losses of energy in rotating mechanical parts, suffers with environmental and sound pollution.

### SUMMARY OF INVENTION

Wind flow operated ventilation and energy harnessing device is based on the creation of lee-ward side evacuation effect and windward side pressurization effect, after and before an obstruction, respectively falling normal to the wind flow path. In this way the use of rotating part is avoided. A direction changer maintains the said obstruction normal to the direction of wind flow.

One of these obstructions is the back side of a flared collar, made at the end of a flow pipe, facing upstream wind flow. This creates a vacuum on the leeward side of the obstruction at the central axis of said flow pipe and consequently the air is sucked out of the room to which the said flow pipe is connected.

The other type of the obstruction is a bell shaped mouth, made at the end of another flow pipe, facing upstream wind flow. This causes windward side pressurization effect and pushes the fresh pressurized air inside the space to which the said flow pipe is connected.

### DESCRIPTION OF THE INVENTION

To mitigate the above said drawbacks as experienced with the here-to-fore known natural wind flow operated ventilation devices, there is provided in the present invention, wind flow operated ventilation and energy harnessing device comprising a substantially L-shaped flow pipe with two portions substantially perpendicular to one another. One of these two portions is sweep able in horizontal plane with the help of the other (vertical) portion rotatable on bearing(s) mounted inside/outside on a stationary vertical pipe. The other end of said stationary vertical pipe is attached with the space (being ventilated). The mating surfaces at the open end of the vertical portion of said flow pipe and said stationary vertical pipe is sealed for preventing air leak with the help of air seal(s).

As regards the mode of ventilation, the said flow pipes are of the following two types: evacuating flow pipe and pressurizing flow pipe.

In an evacuating flow pipe the open end of the horizontal portion of said flow pipe is flared into a substantially perpendicular collar with smooth curvature at the root. A direction changer is attached fixedly vertical with the edge of said collar, aligned along the axis of the horizontal portion of said evacuating flow pipe and extending opposite to the central axis of said stationary vertical pipe.

In a pressurizing flow pipe the open end of the horizontal portion of said flow pipe is formed into a bell-shaped mouth coaxially with the horizontal portion. A direction changer, in this case, is attached fixedly vertical with the back of the bend of said pressurizing flow pipe, aligned along the axis of the horizontal portion of said pressurizing flow pipe and extending opposite to the central axis of said stationary vertical pipe.

In the case of an evacuating flow pipe the upstream wind, on getting obstructed by the back side of said collar, flaring along the smooth curvature (at the root of said collar), bending towards the lee-ward side round the edge of said collar and finally straightens again to merge with the downstream. As a consequence of this, a vacuum gets created towards the lee-ward side, the most pronounced being at the central axis of the horizontal portion of said evacuating flow pipe in the close proximity of said collar. The vacuum so created sucks in air, through said stationary vertical pipe, from the said space (being ventilated) to which said stationary vertical pipe is connected. The air sucked in by this process is thrown out into the downstream wind. In the situation of a change in the direction of wind flow the said direction changer gets pushed aside by turning the said flow pipe on said bearing(s) for setting itself trailing along the new direction of wind flow. This maintains thereby the back of said collar always facing upstream wind. The process of the evacuation of air from the said space (being ventilated) by natural wind flowing above, underneath or by the side(s) of the said space (being ventilated) continues on so long as the wind keeps on flowing past said collar.

In the case of a pressurizing flow pipe the upstream wind, entering through the open end of said bell-shaped mouth facing upstream, gets compressed due to the windward side pressurization effect. This pressurized wind gets pushed into the said space (being ventilated) through said stationary vertical pipe. In the situation of a change in the direction of wind flow said direction changer gets pushed aside by turning the said flow pipe on said bearing(s) for setting itself trailing along the new direction of wind flow. This maintains thereby the open end of the said bell-shaped mouth always facing upstream wind. The fresh pressurized air continues on being pushed, through said stationary vertical pipe, into the said space (being ventilated) so long as the wind flowing above, underneath or by the side(s) of the said space (being ventilated) keeps on entering through said bell-shaped mouth.

In order to harness a portion of energy for other useful purposes, besides the ventilation effect, from natural wind flow, by this device, at least one suitable wind rotor/turbine is installed at least at one suitable location inside said stationary vertical pipe of at least one said evacuating flow pipe or/and at least one said pressurizing flow pipe to suit the comparative need of ventilation and energy.

At least one said evacuating flow pipe or at least one said pressurizing flow pipe or at least one combination of both, attached at suitable location(s) with the walls/roofs of said space (being ventilated), is used to maintain the evacuation of used-up air from and the injection of fresh air into the said space (being ventilated) as per the quantity and the quality of the available wind and the scale of ventilation required.

According to a preferred feature of the present invention at least one said wind rotor/turbine is installed, preferably inside said stationary vertical pipe of said evacuating flow pipe at a location nearest to the said space (being ventilated), the said space here functioning as a reservoir of the pressurized air for inlet to the said wind rotor/turbine.

### ADVANTAGEOUS EFFECT OF THE INVENTION

This invention makes direct use of the lee-ward side evacuation effect of wind flowing past an obstacle and the windward side pressurization effect of wind flowing before an obstruction for sucking up air out from and pushing fresh air into the said space (being ventilated), respectively for achieving ventilation effect. The direct conversion of the wind flow energy into ventilation effect helps in avoiding the losses which otherwise might occur due to the involvement of rotating parts. All these above said benefits are obtained from a non-conventional source of energy of wind flow without burning fuel. In this way it is helpful in cutting down expenditure on fuel as well as in restricting global warming.

This invention will now be illustrated by the way of example with the help of the accompanying drawings:

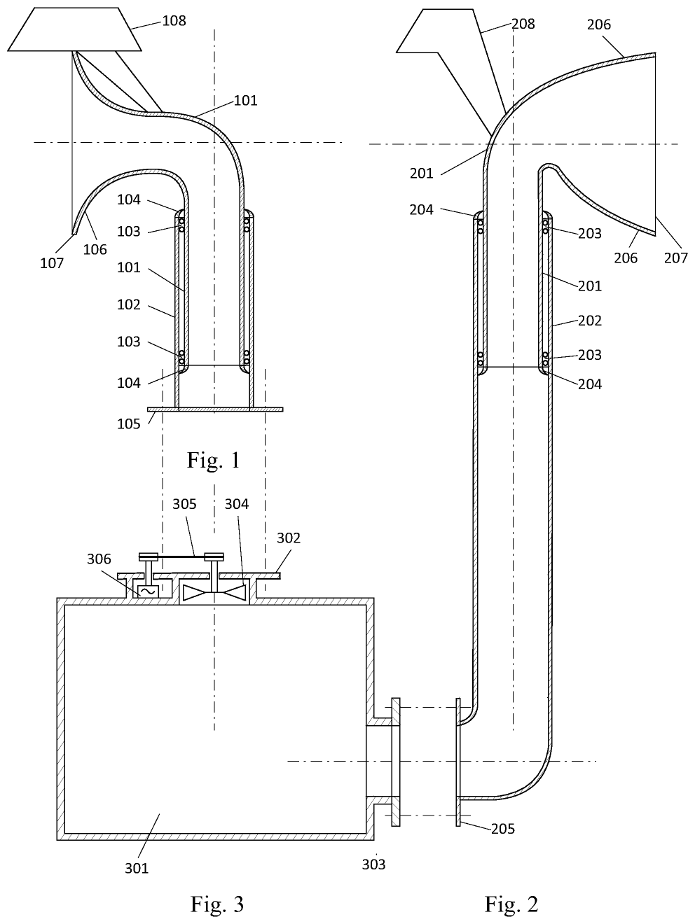

FIG. 1: sectional elevation of evacuating flow pipe with the following details:

101: flow pipe.

102: stationary vertical pipe.

103: bearing.

104: air seal.

105: flange at the open end of stationary vertical pipe 102 for attaching it with the flange 302 (FIG. 3) of the space (being ventilated) 301 (FIG. 3).

106: flared horizontal end of flow pipe 101.

107: collar at the flared end 106 of flow pipe 101.

108: direction changer attached fixedly vertical with the edge of collar 107 of flow pipe 101, aligned along the axis of the horizontal portion of flow pipe 101 and extending opposite to the central axis of stationary vertical pipe 102.

FIG. 2: sectional elevation of pressurizing flow pipe with the following details:

201: flow pipe.

202: stationary vertical pipe.

203: bearing.

204: air seal.

205: flange at the open end of stationary vertical pipe 202 for attaching it with the flange 303 of the space (being ventilated) 301 (FIG. 3).

206: bell-shaped mouth formed at the open end of the horizontal portion of flow pipe 201.

207: open end of bell-shaped mouth 206.

208: direction changer attached fixedly vertical with the back of the bend of bell-shaped mouth 206, aligned along the axis of bell-shaped mouth 206 of flow pipe 201 and extending opposite to the central axis of stationary vertical pipe 202.

FIG. 3: schematic view of the space being ventilated with the following details:

301: space being ventilated.

302: flange attached with the hole in the wall of space (being ventilated) 301 for attaching with the flange 105 of stationary vertical pipe 102 of evacuating flow pipe (FIG. 1).

303: flange attached with the hole in the wall of space (being ventilated) 301 for attaching with the flange 205 of stationary vertical pipe 202 of pressurizing flow pipe (FIG. 2).

304: wind rotor/turbine fitted detachably inside the flange 302.

305: belt and pulley arrangement for transmitting power from wind rotor/turbine 304 to the electric generator 306.

306: electric generator.

With reference to the above said details wind flow operated ventilation and energy harnessing device comprises a substantially L-shaped flow pipe 101/201 with two portions substantially perpendicular to one another. One of these portions 106/206 is sweep able in horizontal plane with the help of the other (vertical) portion rotatable on bearing(s) 103/203 mounted inside/outside on stationary vertical pipe 102/202. The other end of the stationary vertical pipe 102/202 is provided with flange 105/205 for attaching it detachably with the flange 302/303 of the space (being ventilated) 301. The mating surfaces at the open end of the vertical portion of flow pipe 101/201 and of the stationary vertical pipe 102/202 is sealed for preventing air leak with the help of air seals 104/204.

As regards the mode of ventilation, the said flow pipes are of the following two types: evacuating flow pipe (FIG. 1) and pressurizing flow pipe (FIG. 2).

In an evacuating flow pipe (FIG. 1) the open end of the horizontal portion 106 of flow pipe 101 is flared into a substantially perpendicular collar 107 with smooth curvature at the root. A direction changer 108 is attached fixedly vertical with the edge of collar 107, aligned along the axis of the horizontal portion 106 of flow pipe 101 and extending opposite to the central axis of stationary vertical pipe 102.

In a pressurizing flow pipe (FIG. 2) the open end of the of horizontal portion of flow pipe 201 is formed into bell-shaped mouth 206 coaxially with its horizontal portion. A direction changer 208, in this case, is attached fixedly vertical with the back of the bend of pressurizing flow pipe 201, aligned along the axis of the horizontal portion of pressurizing flow pipe 201 and extending opposite to the central axis of stationary vertical pipe 202.

In the case of an evacuating flow pipe (FIG. 1) the upstream wind, on getting obstructed by the back side of collar 107, flaring along the smooth curvature (at the root of the collar 107), bending towards the lee-ward side round the edge of collar 107 and finally straightens again to merge with the downstream. As a consequence of this, a vacuum gets created towards the lee-ward side, the most pronounced being at the central axis of the horizontal portion of evacuating flow pipe 101 in the close proximity of collar 107. The vacuum so created sucks in air, through the stationary vertical pipe 102, from the space (being ventilated) 301 to which stationary vertical pipe 102 is connected. The air sucked in by this process is thrown out into the downstream wind.

In the situation of a change in the direction of wind flow the direction changer 108 gets pushed aside by turning flow pipe 101 on bearing 103 for setting itself trailing along the new direction of wind flow. This maintains thereby the back of collar 107 always facing upstream wind. The process of the evacuation of air from the space (being ventilated) 301 by natural wind flowing above, underneath or by the side(s) of the space (being ventilated) 301 continues on so long as the wind keeps on flowing past collar 107.

In the case a pressurizing flow pipe (FIG. 2) the upstream wind, entering through the open end 207 of bell-shaped mouth 206 facing upstream, gets compressed due to windward side pressurization effect. This pressurized wind gets pushed into the space 301 through stationary vertical pipe 202. In the situation of a change in the direction of wind flow the direction changer 208 gets pushed aside by turning flow pipe 201 on bearing 203 for setting itself trailing along the new direction of wind flow. This maintains thereby the open end 207 of bell-shaped mouth 206 always facing the upstream wind. The fresh pressurized air continues on being pushed, through stationary vertical pipe 202, into space 301 so long as the wind flowing above, underneath or by the side of space 301 keeps on entering into bell-shaped mouth 206.

In order to harness a portion of energy for other useful purposes besides the ventilation effect from natural wind flow, by this device, a wind rotor 304 is installed inside the flange 302 (which is fitted with space 301 for attaching with flange 105 of evacuating flow pipe (FIG. 1)). The belt pulley system 305 is provided for transmitting power to the generator 306.

A combination of evacuating flow pipe (FIG. 1) and pressurizing flow pipe (FIG. 2), with the help of flanges 105/205 attached detachably to the corresponding flanges 302/303 of the walls/roofs of space 301 is used to maintain the evacuation of used-up air from and the injection of fresh air into the space 301 till so long as the wind is flowing past collar 107 or entering into bell-shaped mouth 207.

Thus, there is provided, in the present invention, wind flow operated ventilation and energy harnessing device comprising a substantially L-shaped flow pipe with two portions substantially perpendicular to one another, one of these two portions being sweep able in horizontal plane with the help of the other (vertical) portion rotatable on bearing(s) mounted inside/outside on a stationary vertical pipe, the other end of said stationary vertical pipe being attached with the space (being ventilated), the mating surfaces at the open end of the vertical portion of said flow pipe and said stationary vertical pipe being sealed for preventing air leak with the help of air seal(s), as regards the mode of ventilation, the said flow pipes being of the following two types; evacuating flow pipe and pressurizing flow pipe, in an evacuating flow pipe the open end of the horizontal portion of said flow pipe being flared into a substantially perpendicular collar with smooth curvature at the root, a direction changer being attached fixedly vertical with the edge of said collar, aligned along the axis of the horizontal portion of said evacuating flow pipe and extending opposite to the central axis of said stationary vertical pipe, in a pressurizing flow pipe the open end of the horizontal portion of said flow pipe being formed into a bell-shaped mouth coaxially with the horizontal portion, a direction changer, in this case, being attached fixedly vertical with the back of the bend of said pressurizing flow pipe, aligned along the axis of the horizontal portion of said pressurizing flow pipe and extending opposite to the central axis of said stationary vertical pipe, in the case of an evacuating flow pipe the upstream wind, on getting obstructed by the back side of said collar, flaring along the smooth curvature (at the root of said collar), bending towards the lee-ward side round the edge of said collar and finally straightening again to merge with the downstream, as a consequence of this, a vacuum getting created towards the lee-ward side, the most pronounced being at the central axis of the horizontal portion of said evacuating flow pipe in the close proximity of said collar, the vacuum so created sucking in air, through said stationary vertical pipe, from the said space (being ventilated) to which said stationary vertical pipe being connected, the air sucked in by this process being thrown out into the downstream wind, in the situation of a change in the direction of wind flow the said direction changer getting pushed aside by turning the said flow pipe on said bearing(s) for setting itself trailing along the new direction of wind flow, maintaining thereby the back of said collar always facing upstream wind, the process of the evacuation of air from the said space (being ventilated) by natural wind flowing above, underneath or by the side(s) of said space (being ventilated) continuing on so long as the wind keeping on flowing past said collar, in the case of a pressurizing flow pipe the upstream wind, entering through the open end of said bell-shaped mouth facing upstream, getting compressed due to the windward side pressurization effect, this pressurized wind getting pushed into the said space (being ventilated) through said stationary vertical pipe, in the situation of a change in the direction of wind flow said direction changer getting pushed aside by turning the said flow pipe on said bearing(s) for setting itself trailing along the new direction of wind flow, maintaining thereby the open end of the said bell-shaped mouth always facing upstream wind, the fresh pressurized air continuing on being pushed, through said stationary vertical pipe, into the said space (being ventilated) so long as the wind flowing above, underneath or by the side(s) of the said space (being ventilated) keeping on entering trough said bell-shaped mouth, in order to harness a portion of energy for other useful purposes, besides the ventilation effect, from natural wind flow, by this deice, at least one suitable wind rotor/turbine being installed at least at one suitable location inside said stationary vertical pipe of at least one said evacuating flow pipe or/and at least one said pressurizing flow pipe to suit the comparative need of ventilation and energy, at least one said evacuating flow pipe or at least one said pressurizing flow pipe or at least one combination of both, attached at suitable location(s) with the walls/roofs of said space (being ventilated), being used to maintain the evacuation of used-up air from and the injection of fresh air into the said space (being ventilated) as per the quantity and the quality of the available wind and the scale of ventilation required.

According to a preferred feature of the present invention at least one said wind rotor/turbine is installed, preferably inside said stationary vertical pipe of said evacuating flow pipe at a location nearest to the said space (being ventilated), the said space here functioning as a reservoir of the pressurized air for inlet to the said wind rotor/turbine.

Wind flow operated ventilation and energy harnessing device substantially as herein described and illustrated in the figures of the accompanying drawings and as described herein with reference thereto is only by the way of example. It should be understood that various other changes, omission and addition may be made without departing from the spirit or without restricting the scope of this invention.

The materials, design or construction of said flow pipes, bearings, air seals, direction changers, rotor/turbine and flow control means may be adopted in many ways as and when needed and are not critical in this invention.

The said stationary vertical pipe, except for the portion harboring said bearing housing may be made of duct (s) of any suitable shape, size, configuration, adjustability and inclination to suit the site conditions and are not critical in this invention.

The said vertical pipe or its linking duct (s) portion(s) may get made to pass through heat exchanger(s) receiving/rejecting heat from/to any known source/sink for maintaining conditioned air to suit the need and the comfort and are not critical in this invention.

A sufficiently long horizontal stationary portion of said evacuating flow pipe acts itself as direction changer, hence in that case the use of a separate direction changer may be avoided without restricting to the scope of this invention.

1. Wind flow operated ventilation and energy harnessing device comprising a substantially L-shaped flow pipe with two portions substantially perpendicular to one another, one of these two portions being sweep able in horizontal plane with the help of the other (vertical) portion rotatable on bearing(s) mounted inside/outside on a stationary vertical pipe, the other end of said stationary vertical pipe being attached with the space (being ventilated), the mating surfaces at the open end of the vertical portion of said flow pipe and said stationary vertical pipe being sealed for preventing air leak with the help of air seal(s), as regards the mode of ventilation, the said flow pipes being of the following two types; evacuating flow pipe and pressurizing flow pipe, in an evacuating flow pipe the open end of the horizontal portion of said flow pipe being flared into a substantially perpendicular collar with smooth curvature at the root, a direction changer being attached fixedly vertical with the edge of said collar, aligned along the axis of the horizontal portion of said evacuating flow pipe and extending opposite to the central axis of said stationary vertical pipe, in a pressurizing flow pipe the open end of the horizontal portion of said flow pipe being formed into a bell-shaped mouth coaxially with the horizontal portion, a direction changer, in this case, being attached fixedly vertical with the back of the bend of said pressurizing flow pipe, aligned along the axis of the horizontal portion of said pressurizing flow pipe and extending opposite to the central axis of said stationary vertical pipe, in the case of an evacuating flow pipe the upstream wind, on getting obstructed by the back side of said collar, flaring along the smooth curvature (at the root of said collar), bending towards the lee-ward side round the edge of said collar and finally straightening again to merge with the downstream, as a consequence of this, a vacuum getting created towards the lee-ward side, the most pronounced being at the central axis of the horizontal portion of said evacuating flow pipe in the close proximity of said collar, the vacuum so created sucking in air, through said stationary vertical pipe, from the said space (being ventilated) to which said stationary vertical pipe being connected, the air sucked in by this process being thrown out into the downstream wind, in the situation of a change in the direction of wind flow the said direction changer getting pushed aside by turning the said flow pipe on said bearing(s) for setting itself trailing along the new direction of wind flow, maintaining thereby the back of said collar always facing upstream wind, the process of the evacuation of air from the said space (being ventilated) by natural wind flowing above, underneath or by the side(s) of the said space (being ventilated) continuing on so long as the wind keeping on flowing past said collar, in the case of a pressurizing flow pipe the upstream wind, entering through the open end of said bell-shaped mouth facing upstream, getting compressed due to the windward side pressurization effect, this pressurized wind getting pushed into the said space (being ventilated) through said stationary vertical pipe, in the situation of a change in the direction of wind flow said direction changer getting pushed aside by turning the said flow pipe on said bearing(s) for setting itself trailing along the new direction of wind flow, maintaining thereby the open end of the said bell-shaped mouth always facing upstream wind, the fresh pressurized air continuing on being pushed, through said stationary vertical pipe, into the said space (being ventilated) so long as the wind flowing above, underneath or by the side(s) of the said space (being ventilated) keeping on entering through said bell-shaped mouth, in order to harness a portion of energy for other useful purposes, besides the ventilation effect, from natural wind flow, by this device, at least one suitable wind rotor/turbine being installed at least at one suitable location inside said stationary vertical pipe of at least one said evacuating flow pipe or/and at least one said pressurizing flow pipe to suit the comparative need of ventilation and energy, at least one said evacuating flow pipe or at least one said pressurizing flow pipe or at least one combination of both, attached at suitable location(s) with the walls/roofs of said space (being ventilated), being used to maintain the evacuation of used-up air from and the injection of fresh air into the said space (being ventilated) as per the quantity and the quality of the available wind and the scale of ventilation required.

2. Wind flow operated ventilation and energy harnessing device as claimed in claim 1, wherein at least one said wind rotor/turbine is installed, preferably inside said stationary vertical pipe of said evacuating flow pipe at a location nearest to the said space (being ventilated), the said space here functioning as a reservoir of the pressurized air for inlet to the said wind rotor/turbine.

3. Wind flow operated ventilation and energy harnessing device substantially as herein described and illustrated in the figures of the accompanying drawings.
